(19) United States
(12) Patent Application Publication
(10) Pub. No.: US 2016/0055035 A1
(43) Pub. Date: Feb. 25, 2016

(54) MULTIPLE SIMULTANEOUS REQUEST RESOURCE MANAGEMENT

(71) Applicant: Raytheon Company, Waltham, MA (US)

(72) Inventors: Ray T. Hsu, Rancho Palos Verdes, CA (US); Harry B. Marr, Manhattan Beach, CA (US); Frank N. Cheung, Agoura, CA (US)

(21) Appl. No.: 14/640,338

(22) Filed: Mar. 6, 2015

Related U.S. Application Data
(60) Provisional application No. 62/037,455, filed on Aug. 14, 2014.

(51) Int. Cl. G06F 9/50

(52) U.S. Cl. CPC G06F 9/5038

(57) ABSTRACT

A method for scheduling a plurality of resources for processing a plurality of requests is provided. The method sorts the requests, each specifying a priority and one or more resources that process the request, in parallel based on the priorities. The method initializes an output set to an empty set and filters out any request that has a resource conflict with a current highest priority request, adds the current highest priority request to the output set and determines whether one or more requests of the plurality of requests, other than the requests added to the output set, are not filtered out. Responsive to determining that the one or more requests are not filtered out, repeating filtering, adding, and determining by using a highest priority request of the one or more requests as a current highest priority request. The method causes the assigned resources to process the output set of requests in parallel.

### CROSS REFERENCE TO RELATED APPLICATIONS

This application claims benefit of U.S. Provisional Patent Application Ser. No. 62/037,455, filed Aug. 14, 2014; which is incorporated herein in its entirety.

### BACKGROUND

The present disclosure relates generally to managing several resources and several requests processed by the resources, and more specifically, to a system for scheduling a limited quantity of resources for processing several requests in parallel.

Many computer task scheduling systems have been developed for handling a wide variety of different computational scenarios. Some computational scenarios involve a large number of requests to be processed by a limited number of computational resources. It is often difficult to schedule computational resources to process the requests efficiently, due to the complexities and unpredictability of the requests. For instance, in electronic warfare, many simultaneous threats need to be countered where the number of threats may greatly outnumber the quantity of computational resources used to counter the threats, and an amount of time that is needed to process each threat using the resources may not be known ahead of time.

### SUMMARY

Embodiments include a computer program product, a method, and a system for scheduling a plurality of resources for processing a plurality of requests in parallel. According to an embodiment of the present invention, a computer program product for scheduling a plurality of resources for processing a plurality of requests in parallel is provided. The computer program product comprises a computer readable storage medium having program instructions embodied therewith. The program instructions readable by a processing circuit cause the processing circuit to perform a method. The method sorts the requests, each specifying a priority and one or more resources that process the request, in parallel based on the priorities of the requests. The method initializes an output set of requests to an empty set. The method filters out any request that has a resource conflict with a current highest priority request. The method adds the current highest priority request to the output set. The method determines whether one or more requests of the plurality of requests, other than the requests added to the output set, are not filtered out. Responsive to determining that the one or more requests are not filtered out, the method repeats the filtering, the adding, and the determining by using a highest priority request of the one or more requests as a current highest priority request. The method causes the assigned resources to process the output set of requests in parallel.

According to another embodiment of the present invention, a computer system for scheduling a plurality of resources for processing a plurality of requests in parallel is provided. The computer system comprises a memory having computer readable instructions and a processor configured to execute the computer readable instructions. The instructions include sorting the request, each specifying a priority and one or more resources that process the request, in parallel based on the priorities of the requests. The instructions further include initializing an output set of requests to an empty set. The instructions further include filtering out any request that has a resource conflict with a current highest priority request. The instructions further include adding the current highest priority request to the output set. The instructions further include determining whether one or more requests of the plurality of requests, other than the requests added to the output set, are not filtered out. The instructions further include, responsive to determining that the one or more requests are not filtered out, repeating the filtering, the adding, and the determining by using a highest priority request of the one or more requests as a current highest priority request. The instructions further include causing the assigned resources to process the output set of requests in parallel.

According to a further embodiment of the present invention, a method for scheduling a plurality of resources for processing a plurality of requests in parallel is provided. The method sorts the requests, each specifying a priority and one or more resources that process the request, in parallel based on the priorities of the requests. The method initializes an output set of requests to an empty set. The method filters out any request that has a resource conflict with a current highest priority request. The method adds the current highest priority request to the output set. The method determines whether one or more requests of the plurality of requests, other than the requests added to the output set, are not filtered out. Responsive to determining that the one or more requests are not filtered out, the method repeats the filtering, the adding, and the determining by using a highest priority request of the one or more requests as a current highest priority request. The method causes the assigned resources to process the output set of requests in parallel.

### BRIEF DESCRIPTION OF THE SEVERAL VIEWS OF THE DRAWINGS

The subject matter which is regarded as the invention is particularly pointed out and distinctly claimed in the claims at the conclusion of the specification. The foregoing and other features, and advantages of the disclosure are apparent from the following detailed description taken in conjunction with the accompanying drawings in which:

FIG. 1 depicts a block diagram of a scheduling system in accordance with some embodiments of the invention;

FIG. 2 depicts a process flow for scheduling a plurality of resources for processing a plurality of requests in accordance with some embodiments of the invention; and

FIG. 3 illustrates a table in different stages in accordance with some embodiments of the invention.

### DETAILED DESCRIPTION

In an electronic warfare scenario involving radar use, a capability to counter many simultaneous threats using radar resources is desired. However, the number of simultaneous threats often greatly outnumbers the number of radar resources used to counter the threats. Radar resources for jamming and sensing need to be allocated efficiently in order to jam multiple threats and switch between the threats quickly. The use of the radar resources may not be prescheduled because an amount of time to counter each threat may not be known beforehand. Moreover, different jamming requests have different priorities, where a request with the highest priority must be instantly allocated regardless of the current state of resources or other lower priority requests.

Conventional scheduling systems do not handle a large number of requests very well. An amount of time these systems take to assign resources to the requests depends on the number of requests, and thus the assignment may take as many clock cycles as the number of requests. That is, an amount of time that these conventional systems to grant or deny the requests corresponds to the number of requests made.

Because the amount of time that these conventional systems take to grant or deny the requests depends on the number of requests, the conventional systems can only handle the requests at the millisecond level. Therefore, in the context of radar use, these conventional systems can only manage at the mode or dwell level (e.g., manage which radar modes will run and which dwells get scheduled) and are not fast enough to handle the requests at the pulse level.

Some conventional systems may use an arbitration approach to handle multiple requests competing for the same resource, but the arbitration approach cannot handle cases where one request needs multiple resources simultaneously. Some conventional systems handle such cases by using a lookup table (LUT) with all possible resource-to-request assignment combinations predefined in the LUT. It is, however, not feasible to implement such a huge LUT in a small circuit environment (e.g., in a Field-Programmable Gate Array (FPGA) circuit) because, for larger numbers of requests and/or resources, the complexity of arbitration or mapping grows exponentially.

Embodiments of the invention are resource-based because the embodiments use output resource conflict to determine the best prioritized input request combination. Such a resource-based approach reduces the complexity greatly as the approach depends on the number of resources, rather than on the number of requests. This drastic reduction makes it feasible for the decision making algorithm to be computed in real time, in a small circuit that will fit in a FPGA.

While described in the context of electronic warfare involving radar use, the above scenarios are representative of scheduling scenarios where there are a limited number of resources for processing in parallel a larger number of requests having different priorities. Embodiments of the invention provide methods and systems that are capable of granting or denying multiple contemporaneous requests in a fixed, short amount of time that depends on the number of resources that process the requests and is independent of the number of requests and request priorities. The methods and systems optimally schedule a limited number of resources for processing in parallel the maximum possible number of requests having different priorities.

The methods and systems sort all requests in a queue based on priorities specified in the requests. Specifically, in some embodiments, the methods and system sorts the request using a hash function such that the sort is done in a single computational step as opposed to other conventional methods and systems that typically require log(n) steps where log( ) is the logarithm function and n is the number of requests. The methods and systems assign the highest priority request to the resources, and filter out those requests that have resource conflicts with the highest priority request. The methods and systems then move down to the next highest available priority request and perform assigning and filtering to filter out the requests that have resource conflicts with this next highest available priority request. In this manner, the requests are assigned to the resources much faster (e.g., because multiple requests are assigned to the resources together) than when a request is assigned to resource(s) one at a time.

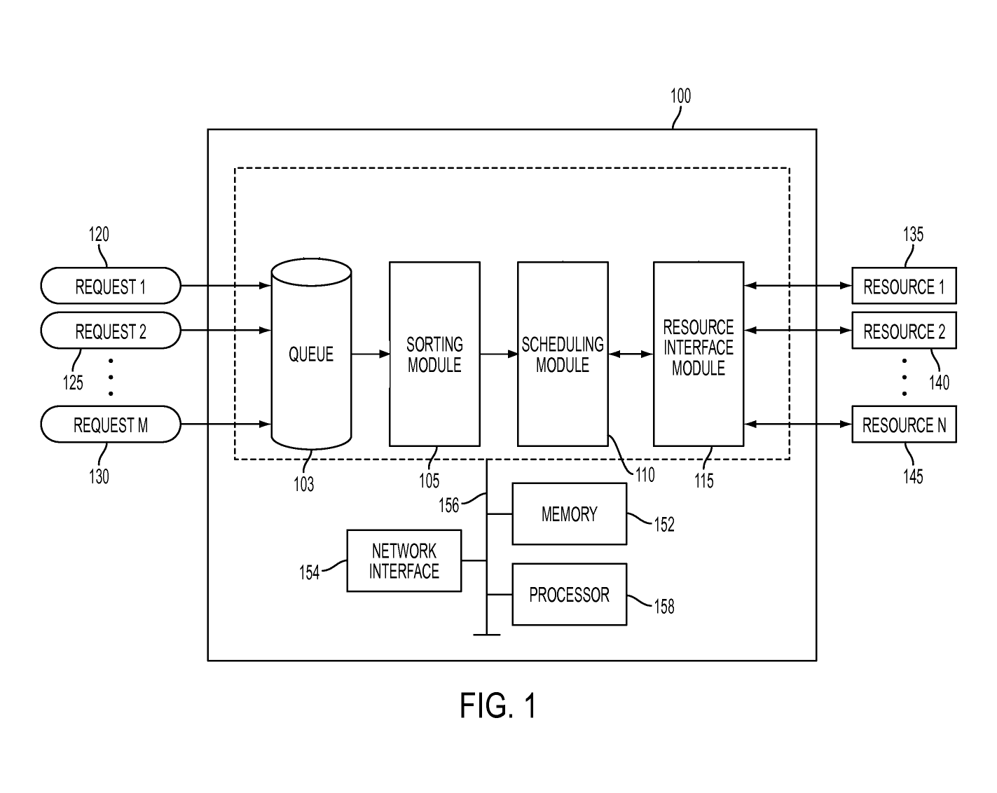

FIG. 1 depicts a block diagram of a scheduling system 100 in accordance with some embodiments of the invention. As shown, the scheduling system 100 of some embodiments includes a queue 103, a sorting module 105, a scheduling module 110, and a resource interface module 115. FIG. 1 also illustrates a plurality of requests 120-130 and a plurality of resources 135-145.

The requests 120-130 are requests to be processed by the resources 135-145. In some embodiments, each of the requests 120-130 includes a request identifier (e.g., an alphanumeric value such as RQ1, RQ2, RQ3, etc.), a list of resource(s) that process the request, a priority (e.g., P1, P2, P3, etc. with P1 denoting the highest or the lowest priority), and other data necessary for processing the request. For simplicity of illustration and description, one or more systems, which generate the requests 120-130 and determine the identifier, the list, the priority, and the data for each request, are not depicted in FIG. 1. These system(s) contemporaneously send the requests 120-130 to the scheduling system 100, which deposit the requests in the queue 103. A number of the requests 120-130 is referred to as M in the present disclosure, where M is an integer greater than 1.

Once the requests 120-130 are deposited in the queue 103, the sorting module 105 sorts the requests 120-130 based on the priorities of the requests 120-130. In some embodiments, the sorting module 105 convert data describing the priority of a request into a hash value by using a hash function, and this hash value serves as a unique request identification value, which is referred to as a priority identifier. Specifically, in some embodiments, the sorting module 105, using the hash function, generates a priority identifier based on the identifier of the request (e.g., RQ1) and the priority (e.g., P5). For example, the priority identifier for the request with identifier RQ1 may be a concatenation of RQ1 and the priority P5. As such, the priority identifier is unique for each of the requests 120-130. The sorting module 105 then routes each of the requests 120-130 to one of registers (not shown) that is associated with the priority part of the priority identifier of the request. These registers, by being associated with the priorities of the requests, are deemed sorted based on the priorities. In some embodiments, the sorting module 105 uses switches (not shown) that read the priority identifiers of the requests and route the requests to the associated registers in parallel. That is, each request is routed by the request's own switch. By routing the requests in parallel to the sorted registers, the sorting of the requests is done in a single step (e.g., in one clock cycle). As a specific example, a short list of incoming requests may be a request RQ1 with priority P5, a request RQ2 with priority P6 and a request RQ3 with priority P1. The requests get routed via priority number such that RQ3 gets routed to register 1, RQ1 gets routed to register 5, and RQ2 gets routed to register 6. The registers read in order in this example then are RQ3, RQ1, and RQ2. This list is now sorted by priority.

In this disclosure, a number of the resources 135-145 is referred to as N, which is an integer greater than 1. It is assumed that M, the number of requests 120-130 that are sent to the scheduling system 100 contemporaneously, is much larger (e.g., an order of degree) than N. Also, each resource is assumed to be capable of processing only one request at a time.

The scheduling module 110 schedules the resources 135-145 for processing the sorted requests by checking resource conflicts among the requests. Specifically, the scheduling module 110 first identifies a request with the highest priority from the sorted requests. The scheduling module 110 assigns the resources specified in the list of resources to process this highest priority request. The scheduling module 110 then filters out all requests that have resource conflicts with this highest priority request. That is, for instance, if the list of resources specified in the highest priority request includes the resources 135 and 140, the scheduling module 110 filters out all those requests that specify the resource 135 and/or the resource 140 as the resources to process those requests.

Among the remaining requests that have not been filtered out, the scheduling module 110 identifies a request with the highest priority, assigns the resources specified in this request to this request, and filters out all requests that have resource conflicts with this request. The scheduling module 110 repeats such an iteration of identifying, assigning, and filtering until there is no request that has not been filtered out. It is to be noted that, because there can be up to N requests that may not have resource conflicts, a number of iterations of identifying, assigning, and filtering can only be up to N. That is, a batch of requests is assigned to the resources 135-145 within a guaranteed number of iterations (i.e., N iterations). This allows the amount of time to perform this scheduling process by the scheduling module 110 to be independent of the number of input requests (i.e., M), and rather to be dependent on the number of resources that handles the requests (i.e., N).

The resource interface module 115 sends the requests, to which the resources are assigned by the scheduling module 110, to the resources 135-145 according to the assignments. In some embodiments, the resource interface module 115 (or the scheduling module 110) then removes these requests from the queue 103.

As more requests are sent to the scheduling system 100 and deposited in the queue 103, the sorting module 105 keeps sorting the new requests and the existing requests in the queue 103 based on the priorities. The scheduling module 110 constantly makes resource assignment decision by performing iterations of the identifying, assigning and filtering routines on the prioritized request outputs from the sorting module 105. A new batch of requests is sent to resources interface module 115 when the scheduling module 110 reaches a different resource assignment decision than the one currently being executed by the resource interface module 115. The resource interface module 115 sends out these requests to the resources 135-145 regardless of whether the current processing of the requests by the resources 135-145 are finished or not.

As used herein, the term “module” may refer to a module in a pipeline, an application specific integrated circuit, an electronic circuit, a processor (shared, dedicated, or group) and memory that executes one or more software or firmware programs, or a combinational logic circuit in a server. For example, in some embodiments, the queue 103 may be implemented in a memory 152, and the sorting module 105 may be communicatively connected (e.g., through a bus 156) to the memory 152 to access requests in the queue 103. The scheduling module 110 may be communicatively connected to the memory 152 to access read the requests in the queue 103. The resources 135-145 may be communicatively connected to a network interface 154 to exchange data (e.g., requests, processing status, etc.) with the resource interface module 115. The sorting module 105, the scheduling module 110, and the resource interface module 115 may also use a processor 158 to perform their operations. In an embodiment, the modules 105-115 of the scheduling system 100, may be combined or further partitioned. Also, the modules 105-115 of the scheduling system 100 may be implemented in more than one server in a distributed fashion, or each of the modules 105-115 may be implemented in a different server.

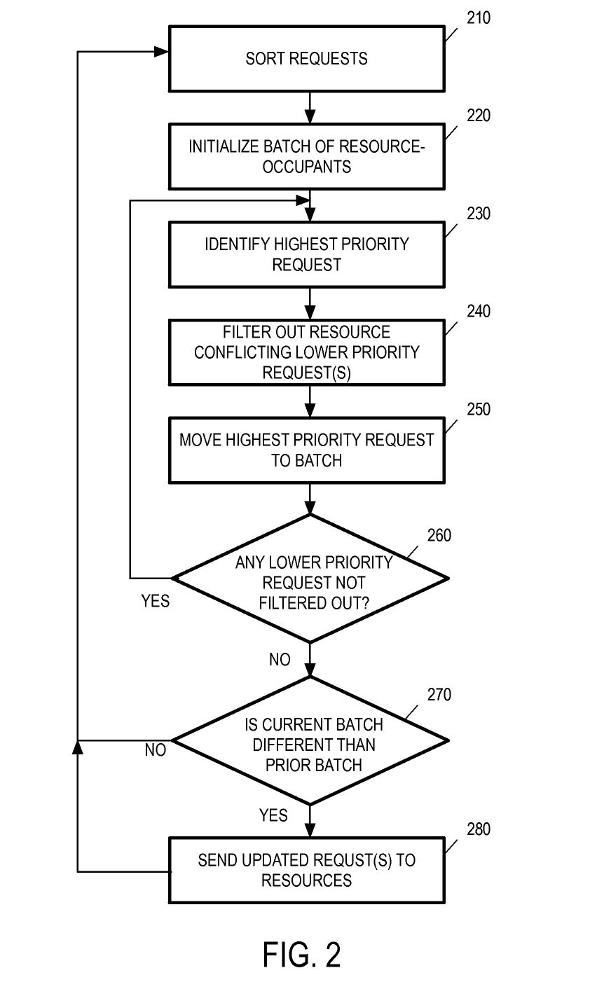

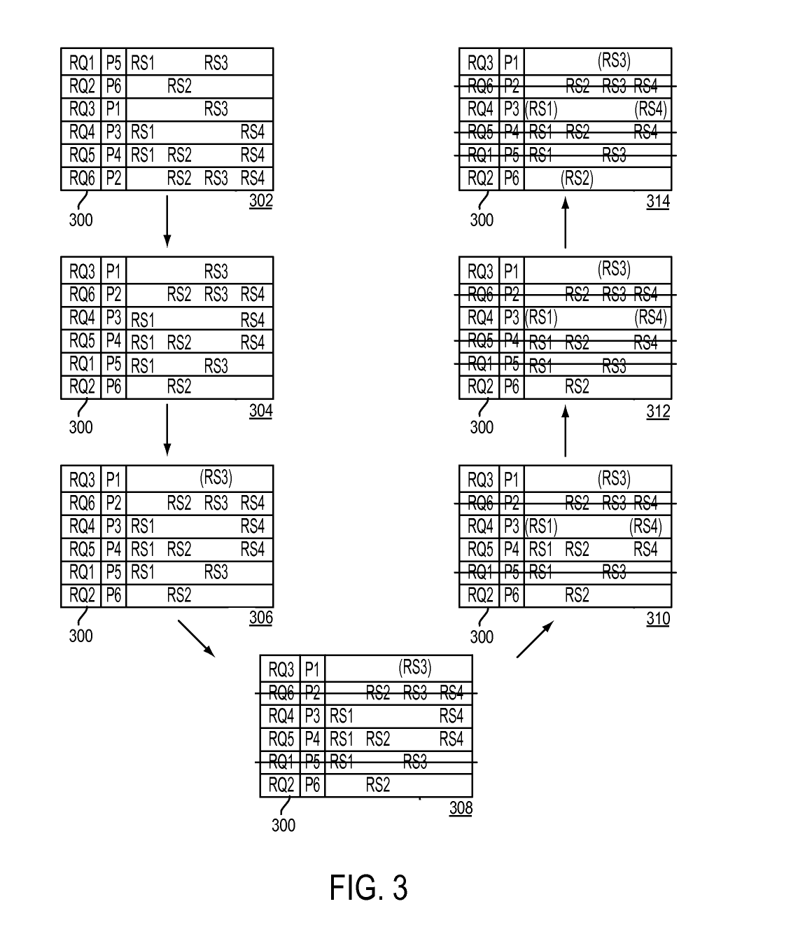

An example operation of the scheduling system 100 will now be described by reference to FIGS. 2 and 3. FIG. 2 depicts a process flow for scheduling a plurality of resources for processing a plurality of requests. In some embodiments, the process flow shown in FIG. 2 is performed by the scheduling system 100. FIG. 3 illustrates a table 300 in seven different stages 302-314. The table 300 represents the queue 103 in which incoming requests are deposited. It is to be noted that the queue 103 does not have to be implemented as a table or in the particular format of the table 300 and that the queue 103 may be implemented in any suitable form on which a plurality of requests may be deposited. As shown in FIG. 3, each row of the table represents a request, and each column represents an attribute of the corresponding request. Specifically, the first column of the table 300 specifies the request identifiers, the second column of the table 300 specifies the priorities, and the third column of the table 300 specifies lists of resources by which the requests are to be processed.

At block 210 in FIG. 2, the scheduling system 100 sorts a plurality of requests in the queue 103 in parallel, using the hash function described above. Stage 302 in FIG. 3 shows that there are six requests with request identifiers RQ1-RQ6 in this example. Requests RQ1-RQ6 have assigned priorities P5, P6, P1, P3, P4, and P2, respectively. In some embodiments, P1 indicates the highest priority and the P6 indicates the lowest priority in the present disclosure. The third column of the table 300 specifies that the request RQ1 should be processed by resources RS1 and RS3, that the request RQ2 should be processed by resource RS2, that the request RQ3 should be processed by resource RS3, that the request RQ4 should be processed by resources RS1 and RS4, that the request RQ5 should be processed by resources RS1, RS2 and RS4, and that the request RQ6 should be processed by resources RS2, RS3, and RS4. Stage 304 shows the table 300 after the scheduling system 100 sorts at block 210 the requests RQ1-RQ6 based on the priorities P1-P6 of the requests. As shown at stage 304, the request RQ3 is now the first entry of the sorted table 300 because the request RQ3 has the highest priority P1, and the request RQ2 is the last entry of the table 300 because the request R2's priority is the lowest priority P6.

At block 220, the scheduling system 100 initializes a batch of resource-occupants to be sent to the resources interface module 115. In some embodiments, the batch is set to an empty batch at block 220. The batch represents an output set of requests that includes requests that have been assigned to resources. The batch is not shown in FIG. 3 for simplicity of illustration.

At block 230, the scheduling system 100 identifies the highest priority request among the plurality of requests sorted at block 210 and assigns the resources specified for the identified highest priority request to this highest priority request. Stage 306 shows that the resource RS3 (i.e., the resource identifier RS3) in the first row of the table 300 is parenthesized to indicate that the resource RS3 is assigned to the highest priority request RQ3.

At block 240, the scheduling system 100 filters out all requests that have resource conflicts with the highest priority request identified at block 230. Specifically, in some embodiments, the scheduling system 100 simultaneously filters out all requests that have resource conflicts in parallel. That is, the requests that have not been filtered out are compared to the current highest priority request simultaneously, in parallel, in order to filter out requests that have resource conflict, in one comparison step (e.g., in one clock cycle). As shown by stage 308, the scheduling system 100 filters out the requests RQ6 and RQ1 because the requests RQ6 and RQ1 have the resource RS3 as the resource to process the requests RQ6 and RQ1. That is, the resource RS3 is taken by the highest priority request RQ3 and cannot take on the request RQ6 or RQ1. Stage 308 shows that the second and the fifth rows of the table 300 are crossed out to indicate that the requests RQ6 and RQ1 are filtered out by the scheduling system 100.

At block 250, the scheduling system 100 moves the highest priority request identified at block 230 to the batch of resource-occupants. That is, RQ3 is added to the batch and is not further considered in this resource filtering operations.

At block 260, the scheduling system 100 determines whether there is at least one request other than the highest priority among the remaining plurality of requests (in the queue 103) that has not been filtered out yet. If there is no such request in the queue 103, the scheduling system 100 proceeds to block 270, which will be described further below. If there is such request in the queue 103, the scheduling system 100 loops back to block 230 to identify the highest priority request among the remaining request(s) that have not been filtered out. In this example, the requests RQ4, RQ5, and RQ2 have not been filtered out as shown at stage 308.

Back at block 230, the scheduling system 100 identifies the highest priority request among the remaining request(s) that have not been filtered out and assigns the resources specified for the identified highest priority request to the this highest priority request. The scheduling system 100 identifies the request RQ4 as the highest priority request among the remaining requests because the request RQ4 has a priority P3 which is higher than the priorities P4 and P6 that the requests RQ5 and RQ2 have, respectively. In some embodiments, the scheduling system 100 identifies the highest priority request by moving a pointer to a next available row, which, in this example, is the third row for the request RQ4 because the second row for the request RQ6 is filtered out (e.g., marked incompatible).

Stage 310 shows that the resources RS1 and RS4 (i.e., the resource identifiers RS1 and RS4) in the third row of the table 300 are parenthesized to indicate that the resources RS1 and RS4 are assigned to the highest priority request RQ4.

At block 240, the scheduling system 100 filters out all requests that have resource conflicts with the highest priority request, which is now RQ4. As shown by stage 312, the scheduling system 100 filters out the request RQ5 because the request RQ5 has the resources RS1 and RS4 as the resources to process the request RQ5. That is, the resources RS1 and RS4 are taken by the highest priority request RQ4 and cannot take on the request RQ5. Stage 312 shows that the fourth row of the table 300 is crossed out to indicate that the request RQ5 is filtered out by the scheduling system 100.

At block 250, the scheduling system 100 moves the current highest priority request identified at block 230 to the batch of resource-occupants. That is, RQ4 is added to the batch and is not further considered in this resource filtering operations. The batch of resource-occupants now has RQ3 and RQ4.

At block 260, the scheduling system 100 determines whether there is at least one request other than the highest priority request in the queue 103 that has not been filtered out yet. In this example, the request RQ2 has not been filtered out as shown at stage 314. Therefore, the scheduling system 100 loops back to block 230 again. The scheduling system 100 then identifies at block 230 the request RQ2 as the highest priority request among the remaining requests. Because the request RQ2 is the only remaining request, the scheduling system 100 filters out nothing at block 240. The scheduling system 100 moves RQ2 to the batch, which then has RQ3, RQ4 and RQ2. The scheduling system 100 determines at block 260 that there is no remaining request that have not been filtered out and thus proceeds to block 270.

At block 270, the scheduling system 100 determines whether the current batch of resource-occupants is different than the prior batch of resource-occupants that was sent to the resources 135-145. In some embodiments, the current batch and the prior batch are deemed different when at least one of the request(s) in the current batch is not in the prior batch. If it is determined at block 270 that the current batch is not different than the prior batch (i.e., if the current batch is the same as the prior batch), the scheduling system 100 loops back to block 210 to receive and sort any new input requests.

If it is determined at block 270 that the current batch is different than the prior batch, the scheduling system proceeds to block 280 to send all of the request(s) in the current batch that are not in the prior batch to the resources to which these requests are assigned. The scheduling system then loops back to block 210 to receive and sort any new input requests.

That is, in this example, the scheduling system 100 sends the requests RQ3 to the resource RS3, sends the request RQ4 to the resources RS1 and RS4, and sends the request RQ2 to the resource RS2. In some embodiments, the scheduling system also removes the requests (e.g., RQ3, RQ4, and RQ2) from the queue 103. In some embodiments, the requests RQ6, RQ5, and RQ1 that are not sent out to resources in this example would be reconsidered by the scheduling system 100 when the scheduling system 100 receives new requests or when the resources are done processing the requests sent to the resources. In other embodiments, the requests RQ6, RQ5, and RQ1 are denied.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer program product for scheduling a plurality of resources for processing a plurality of requests in parallel, the computer program product comprising:
a computer readable storage medium having program instructions embodied therewith, the program instructions readable by a processing circuit to cause the processing circuit to perform a method comprising:
sorting the requests, each specifying a priority and one or more resources that process the request, in parallel based on the priorities of the requests;
initializing an output set of requests to an empty set;
filtering out any request that has a resource conflict with a current highest priority request;
adding the current highest priority request to the output set;
determining whether one or more requests of the plurality of requests, other than the requests added to the output set, are not filtered out;
responsive to determining that the one or more requests are not filtered out, repeating the filtering, the adding, and the determining by using a highest priority request of the one or more requests as a current highest priority request; and
causing the assigned resources to process the output set of requests in parallel.

2. The computer program product of claim 1, wherein the sorting comprises:
assigning a unique identifier to each of the plurality of requests;
concatenating the unique identifier with the priority specified by the request; and
causing the assigned resources to process the output set of requests.

3. The computer program product of claim 2, wherein the method further comprises generating the unique identifier for the request using a hash function.

4. The computer program product of claim 1, wherein a number of the plurality of requests is greater than a number of the plurality of resources.

5. The computer program product of claim 1, wherein a first request does not have a resource conflict with a second request if the set of resources specified by the first request does not overlap with the set of resources specified by the second request.

6. The computer program product of claim 1, wherein a resource is configured to process one request at a time.

7. The computer program product of claim 1, wherein the plurality of requests include at least one request that is being processed by a resource.

8. A computer system for scheduling a plurality of resources for processing a plurality of requests in parallel, the system comprising:
a memory having computer readable instructions; and
a processor configured to execute the computer readable instructions, the instructions comprising:
sorting the requests, each specifying a priority and one or more resources that process the request, in parallel based on the priorities of the requests;
initializing an output set of requests to an empty set;
filtering out any request that has a resource conflict with a current highest priority request;
adding the current highest priority request to the output set;
determining whether one or more requests of the plurality of requests, other than the requests added to the output set, are not filtered out;
responsive to determining that the one or more requests are not filtered out, repeating the filtering, the adding, and the determining by using a highest priority request of the one or more requests as a current highest priority request; and
causing the assigned resources to process the output set of requests in parallel.

9. The computer system of claim 8, wherein the sorting comprises:
assigning a unique identifier to each of the plurality of requests;
concatenating the unique identifier with the priority specified by the request; and
sorting the requests based on the concatenated identifiers and priorities.

10. The computer system of claim 9, wherein the instructions further comprise generating the unique identifier for the request using a hash function.

11. The computer system of claim 8, wherein a number of the plurality of requests is greater than a number of the plurality of resources.

12. The computer system of claim 8, wherein a first request does not have a resource conflict with a second request if the set of resources specified by the first request does not overlap with the set of resources specified by the second request.

13. The computer system of claim 8, wherein a resource is configured to process one request at a time.

14. The computer system of claim 8, wherein the plurality of requests include at least one request that is being processed by a resource.

15. A computer-implemented method of scheduling a plurality of resources for processing a plurality of requests in parallel, the method comprising:
sorting the requests, each specifying a priority and one or more resources that process the request, in parallel based on the priorities of the requests;
initializing an output set of requests to an empty set;
filtering out any request that has a resource conflict with a current highest priority request;
adding the current highest priority request to the output set;
determining, by a computer, whether one or more requests of the plurality of requests, other than the requests added to the output set, are not filtered out;
responsive to determining that the one or more requests are not filtered out, repeating the filtering, the adding, and the determining by using a highest priority request of the one or more requests as a current highest priority request; and
causing the assigned resources to process the output set of requests in parallel.

16. The method of claim 15, wherein the sorting comprises:
assigning a unique identifier to each of the plurality of requests;
concatenating the unique identifier with the priority specified by the request; and
sorting the requests based on the concatenated identifiers and priorities.

17. The method of claim 16, further comprising generating the unique identifier for the request using a hash function.

18. The method of claim 15, wherein a number of the plurality of requests is greater than a number of the plurality of resources.

19. The method of claim 15, wherein a first request does not have a resource conflict with a second request if the set of resources specified by the first request does not overlap with the set of resources specified by the second request.

20. The method of claim 15, wherein a resource is configured to process one request at a time.
